(19) United States
(12) Patent Application Publication
(10) Pub. No.: US 2017/0118963 A1
(43) Pub. Date: May 4, 2017

(54) FARMING APPARATUS FOR AQUATIC ORGANISMS LIVING IN SANDY SOIL

(71) Applicant: HIGASHIMARU CO., LTD., Hioki-shi (JP)

(72) Inventors: Kichitaro HIGASHI, Hioki-shi (JP); Tadami SHIMONO, Hioki-shi (JP); Takahiko SUZUKI, Hioki-shi (JP); Yoshishige FUJII, Yokohama-shi (JP); Koyo MAEDA, Yokohama-shi (JP)

(21) Appl. No.: 15/174,844

(22) Filed: Jun. 6, 2016

(30) Foreign Application Priority Data
Nov. 2, 2015 (JP) 2015-215722
Feb. 24, 2016 (JP) 2016-033298

(51) Int. Cl. A01K 61/00

(52) U.S. Cl. CPC A01K 61/005

(57) ABSTRACT

A farming apparatus for aquatic organisms living in sandy soil, includes: a farming tank; and water feed pipes provided at a constant interval at the bottom of the farming tank; wherein the water feed pipes each have jet openings arranged at a constant pitch on the side faces. The farming apparatus is capable of continuously keeping clean the entire area of the sand layer which provides a living environment for crustaceans and other aquatic organisms living in sandy soil, so that high-quality aquatic organisms living in sandy soil can be produced at a high rate of growth and high density.

### BACKGROUND

Field of the Invention

The present invention relates to a farming apparatus for aquatic organisms living in sandy soil.

Description of the Related Art

Prawns are representative crustaceans living in sandy soil that are eaten in many countries. In particular, Marsupenaeus japonicus is a representative species of crustaceans living in sandy soil and widely used as an expensive food ingredient in Japan. Prawns are nocturnal and remain in sand during the day; they come out on sand for limited hours of the night to search for food.

Technology for farming prawns was achieved around 50 years ago. In Japan and other regions where there is winter, a period not suitable for growth of prawns, farming normally starts by introducing fry around April or May when water temperatures rise, and after they are reared for approximately six months, prawns are harvested at the end of September through the end of the year. In winter when prawns stop growing at low water temperatures, no rearing takes place and water is drained from the farming ponds or tanks to clean the ponds/tanks. In warm regions where water temperatures remain high enough for prawns to grow in winter, farming is timed to allow shipment in winter when few prawns are available on the market; to be specific, prawns are harvested from around November to May and the farming ponds or tanks are cleaned between May and July when fry are produced.

Prawns are farmed largely with one of two methods.

The first method is called the “Setouchi method,” whereby a pond is diked on a beach and the tidal difference is used to change water in the pond. A sand layer of approx. 10 to 20 cm in thickness is made at the bottom of the pond and seawater is filled to around 2 m deep, and water is changed once a day or so to discharge leftover feed, excrement, shed shells, and other contaminants together with water. At spring low tides, the water gate is opened and water is discharged, and the pond is cleaned. To change water, the water level in the pond is adjusted with respect to the tide level to maintain an optimal water level. A filter is installed at the water gate to prevent prawns from flowing out and other aquatic organisms from entering. The Setouchi method is subject to damage due to typhoons, water surges, etc., and is also easily affected by weather, etc., but this farming method requires relatively less labor because fry, or young prawns, are allowed to swim freely and grow at low density.

The second method is called the “flow-over method,” whereby sand is laid on the bottom of a pond or water tank set up on land and fresh seawater is pumped up and flowed over the sand to change water and to discharge contaminants as prawns are raised. There is no need to build dikes, etc., good water quality can be maintained by filtering the supplied seawater, and a relatively high rearing density can be achieved. The flow-over method is associated with high running costs, including the cost of electricity to run the pump and the cost of seawater filtration, and also contaminants that have settled or become buried in the sand cannot be discharged completely.

Besides the conventional farming methods mentioned above, there is the so-called “water-flowing method” whereby a water tank has a second bottom composed of a mesh-like substratum provided 10 to 15 cm above the bottom of the tank, and sand is laid over this second bottom and seawater is constantly made to flow from the top to the bottom of the sand layer to be discharged to remove contaminants. Under the water-flowing method, a large amount of water is discharged from the drainage at the center several times a day so that accumulated contaminants are removed together with this large amount of discharged water. The water-flowing method can achieve higher productivity with smaller area compared to the Setouchi method or flow-over method, but it also requires a large-capacity pump to support frequent water changes of three to four times a day, resulting in high running costs.

As mentioned above, the most serious problem presented by the conventional prawn farming apparatus is that the sand layer in which prawns are reared is contaminated by excrement, etc., and the contaminants left in the sand layer are broken down by microorganisms and turn into ammonia, hydrogen sulfide, and other harmful substances. To avoid contaminated areas, prawns flock to less contaminated areas and the resulting higher concentration of prawns leads to accumulation of excrement, etc., and accelerated contamination over a short period of time. As this process is repeated, less-contaminated areas gradually decrease and the living area for prawns is left only in parts of the farming tank, and consequently the actual rearing density in the farming tank becomes higher than the rearing density calculated from the area of the farming tank. As the rearing density of prawns rises and the living environment deteriorates, stress increases and the rate of growth of prawns drops, and the quality of prawns also drops as they damage each other. Also, an unsanitary environment triggers bacterioses, mycoses, virus infections, and other diseases, killing many prawns and reducing the output.

Raising the rearing density of prawns to increase output causes the living environment to deteriorate further, making more prawns sicken and die and the productivity drops as a result.

Even if prawns are produced by controlling the rearing density and managing it properly, contaminants still accumulate in the sand layer in the farming pond or farming tank and, in some cases, they turn into sludge and solidify the sand layer. For this reason, before fry are introduced in the following year, seawater must be fully drained and the sand layer must be dug up and exposed to air and sunlight, and furthermore it must be cleaned with clear seawater or exchanged with new sand.

Over 3,000 tons of prawns were farmed in the late 1980s in Japan, but the farming output has been hovering around a low level of 1,600 tons or so in recent years. The reasons for this include the difficulty in farming prawns, high disease rates and low productivity, and labor-intensive operations that require a lot of manual work, as mentioned above.

As opposed to the conventional prawn farming methods facing these problems, several farming apparatuses or methods have been proposed whereby contaminants are removed from the sand layer efficiently.

For example, Patent Literature 1 discloses a farming tank that is composed of a drain outlet at the center, a concrete-surface feeding area around the drain outlet, and a rearing area comprising a sand layer laid out around the feeding area. The rearing area is isolated from the feeding area to avoid contamination due to leftover feed. In the san layer, water-supplying outlets are equipped, while also preventing accumulation of contaminants, etc., in the sand.

Patent Literature 2 discloses a rearing method whereby a water tank is covered with a light-shielding housing to adjust the brightness to 100 lux or less at the water surface, while beneficial bacteria are grown in the water tank to keep the transparency to 50 cm or less, and no sand layer where nocturnal prawns go inside is equipped at the bottom of the tank.

Patent Literature 3 discloses a farming system comprising a rearing tank cut off from the external environment, where the tank has a water feed part below a sand layer and high-alkali seawater is supplied therefrom to prevent pathogens from growing.

Patent Literature 4 discloses a farming apparatus comprising a water-permeable porous material on which a sand bed is provided, where external seawater is supplied from below the porous material and passed through a circular cleaning tank equipped along the peripheral wall of a circular tank, during which process the water is forcibly agitated with an enhanced two-stage circulation mechanism to create stronger circular flows to move contaminants in the water toward a drainpipe provided at the center of the circular tank at the bottom.

### BACKGROUND ART LITERATURES

[Patent Literature 1] Japanese Patent Laid-open No. Sho 61-293325

[Patent Literature 2] Japanese Patent Laid-open No. 2006-217895

[Patent Literature 3] Japanese Patent Laid-open No. Hei 11-169011

[Patent Literature 4] Japanese Patent Laid-open No. 2002-360110

### SUMMARY

The present invention provides a farming apparatus capable of continuously keeping clean the entire area of the sand layer which provides a living environment for crustaceans and other aquatic organisms living in sandy soil, so that high-quality aquatic organisms living in sandy soil can be produced at a high rate of growth and high density.

Any discussion of problems and solutions involved in the related art has been included in this disclosure solely for the purposes of providing a context for the present invention, and should not be taken as an admission that any or all of the discussion were known at the time the invention was made.

The inventors of the present invention studied repeatedly in earnest to understand the fundamental problems relating to farming of aquatic organisms living in sandy soil, and conceived the present invention. To be specific, the inventors of the present invention found that deterioration of the living environment was primarily caused by contaminants trapped in the sand layer and not easily removable under the conventional farming apparatuses or methods, and developed a farming apparatus through which contaminants trapped in the sand layer are released efficiently into the water layer so that the entire area of the sand layer can be kept clean and a good living environment can be maintained.

The specific constitutions are as follows:

1. A farming apparatus for aquatic organisms living in sandy soil, comprising:

a farming tank; and

water feed pipes equipped at a constant interval substantially all over a bottom surface of the farming tank wherein bottom parts of the water feed pipes are directly or indirectly in contact with the bottom surface;

characterized in that the water feed pipes each have jet openings arranged at a constant pitch on the side faces.

2. A farming apparatus according to 1, characterized in that the pitch of the jet openings is smaller than the interval of the water feed pipes.

3. A farming apparatus according to 1 or 2, characterized in that the water feed pipes have no closed ends.

4. A farming apparatus according to any one of 1 to 3, characterized in that the jet openings of the water feed pipes do not face directly the adjacent jet openings of the adjacent water feed pipes.

5. A farming apparatus according to any one of 1 to 4, characterized in that the jet openings jet out water in directions of 15 degrees or more to the left/right around the normal line running through the center of the jet opening.

6. A farming apparatus according to any one of 1 to 5, characterized in that water is drained from the center of the farming tank.

7. A farming apparatus according to any one of 1 to 6, characterized in that it has a circular flow generator installed around the interior walls of the farming tank.

The farming apparatus proposed by the present invention has jet openings arranged evenly over the entire bottom surface of the farming tank, so that leftover feed, excrement, shed shells, and other contaminants in the sand layer can be efficiently released into the water layer from the entire area of the sand layer, with contaminants suspended in water released from the farming tank, to prevent hydrogen sulfide and other toxic substances from generating. It can keep the entire area of the sand layer clean, release contaminants from the water layer, and thereby keep the entire sand layer clean.

Using the farming apparatus proposed by the present invention, the entire area of the sand layer can be kept clean and the entire area of the sand layer can be utilized as a living area for aquatic organisms living in sandy soil. Aquatic organisms living in sandy soil do not concentrate locally, but distribute evenly over the entire area of the sand layer to achieve a high rate of growth with less feed. With the farming apparatus proposed by the present invention, prawns can be produced at low mortality and high farming density and the output per unit area can be increased substantially. The farming apparatus proposed by the present invention allows for production of high-quality aquatic organisms living in sandy soil by subjecting the aquatic organisms living in sandy soil to minimal stress.

With the farming apparatus proposed by the present invention, the frequency of cleaning or changing the sand layer can be reduced after the end of farming because fewer contaminants remain in the sand layer, and in some cases the sand layer need not be cleaned or changed. It takes a shorter time to clean the sand layer and, in some cases, cleaning can be eliminated before the next farming cycle is started, which increases the operating hours of the farming apparatus and significantly increases the annual output.

By keeping the pitch of jet openings smaller than the interval of water feed pipes, water can be supplied evenly over the entire area of the sand layer.

Because the water feed pipes have no closed ends, the pressure loss is smaller than when they have closed ends, and the momentum of water jetted out from each of the jet openings in the water feed pipe can be kept uniform.

Jetted-out water penetrates the sand layer and flows out over the sand, sometimes causing the sand layer to have varying thicknesses or not to be cleaned properly. After discovering that one cause of the foregoing relates to how water flows behave in the sand layer, the inventors of the present invention specified the positions and shapes of the pipes and jet openings. Because the water feed pipes are laid in such a way that the jet openings in the adjacent water feed pipes do not face each other, streams of water jetted out from the jet openings in the adjacent water feed pipes do not collide, and this reduces the difference in flow velocity among the upward water flows permeating through the respective parts of the sand layer and prevents the sand layer from varying in thickness.

By jetting out water in directions of 15 degrees or more to the left/right around the normal line running through the center of the jet opening, water can be jetted out over a wide angle and supplied over wide areas of the sand layer.

By draining water from the center of the farming tank, the distance from each part of the farming tank to the drainage can be shortened and the contaminants released into the water layer from the entire area of the sand layer can be discharged efficiently.

By generating circular flows with the circular flow generator to agitate the sand layer lightly, the contaminants carried to the surface of the sand layer by the upward water flows and the contaminants buried in the sand layer are released into the water layer more easily. In addition, this light agitation of the sand layer with the circular flows has the similar effect as the agitation of sand by natural waves and tides, bringing the living environment of prawns, etc., closer to the natural environment and thereby reducing stress on prawns, etc. As water is drained from the center of the farming tank, the contaminants gathered to the center of the farming tank by the circular flows can be discharged more efficiently.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic drawing showing one embodiment of the farming apparatus proposed by the present invention.

FIG. 2 is a schematic drawing showing the interior of the farming apparatus as viewed from direction II in FIG. 1.

FIG. 3 is a schematic drawing showing the flows of water from the jet openings bored in the water feed pipes, as viewed from direction III in FIG. 1.

FIG. 4 is a farming apparatus proposed by the present invention, comprising a circular farming tank and water feed pipes laid in concentric circles in the tank.

FIG. 5 is a farming apparatus proposed by the present invention, whose water feed pipes do not have closed ends.

FIG. 6 is an enlarged view of part IV in FIG. 1.

FIG. 7 is an enlarged view of two adjacent water feed pipes whose jet openings do not face each other.

FIG. 8 is a schematic drawing showing how water is jetted out from jet openings that are narrower on the inner side and wider on the outer side in a horizontal section view.

FIG. 9 is a schematic drawing showing how water is jetted out from jet openings formed with two or more independent pores.

FIG. 10 is a farming apparatus proposed by the present invention, having a circular flow generator.

### DESCRIPTION OF THE SYMBOLS

100 Farming apparatus
10 Farming tank
11 Sand layer
12 Water layer
20 Water feed pipe
20a to 20d Water feed pipe
21 Jet opening
21a to 21d Jet opening
211 Pore
22 Continuous pipe
30 Drainage
31 Filter
32 Pipe
33 External outlet
40 Circular flow generator
101 to 103 Farming apparatus

### DETAILED DESCRIPTION OF EMBODIMENTS

The farming apparatus proposed by the present invention, which is capable of releasing contaminants into the water layer from the entire area of the sand layer to keep the sand layer clean, can be utilized favorably for farming of aquatic organisms living in sandy soil. Examples of aquatic organisms living in sandy soil that can be farmed using the farming apparatus proposed by the present invention include crustaceans such as prawns, blue crabs and mantis shrimps, shellfish such as Manila clams, freshwater clams and hard clams, and fish such as sole and flounder, for example.

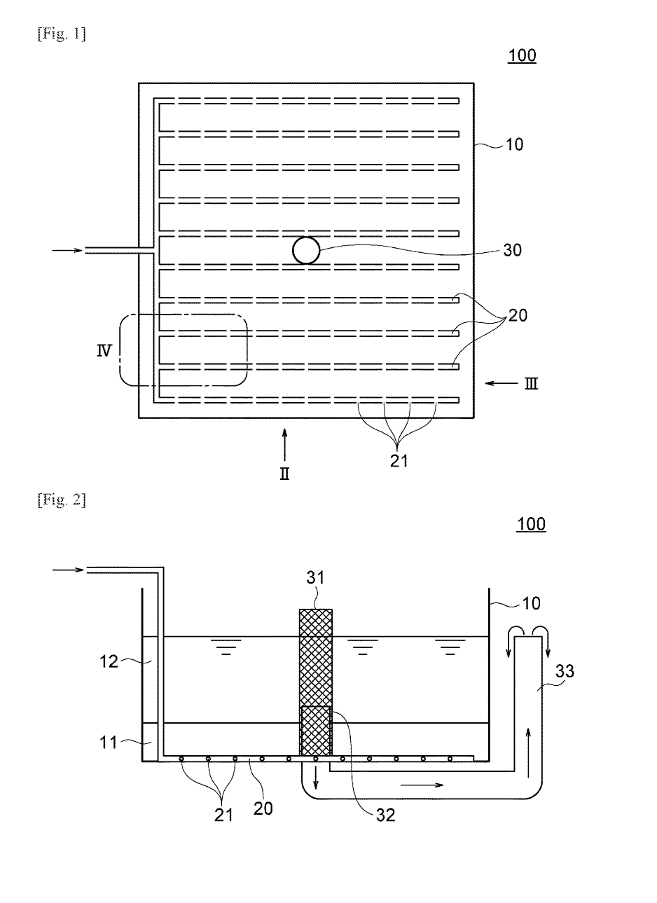

A schematic drawing showing an embodiment of the farming apparatus proposed by the present invention is shown in FIG. 1.

A farming apparatus 100 in this embodiment has a farming tank 10 with ten water feed pipes 20 equipped at a constant interval over the bottom surface, and each water feed pipe 20 has eleven jet openings 21 arranged at a constant pitch on the side faces. It also has a drainage 30 at the center of the farming tank 10.

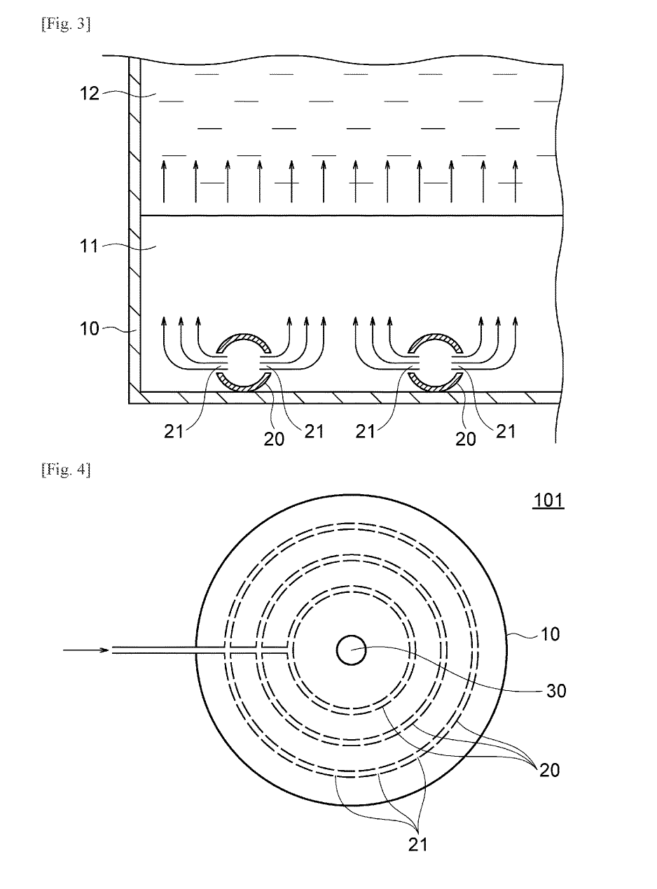

FIG. 2 is a schematic drawing showing the interior of the farming apparatus 100 as viewed from direction II in FIG. 1, while FIG. 3 is a schematic drawing showing the flows of water from the jet openings 21 provided in the water feed pipes 20 as viewed from direction III in FIG. 1.

The farming apparatus 100 jets out water to sides of the water feed pipes 20 from the jet openings 21 on the side faces of the water feed pipes 20. The water feed pipes 20 are embedded under a sand layer 11 on the bottom surface, and the water jetted out to the sides from the jet openings 21 wells out into the sand layer 11 and spreads gradually. Since the water jetted out from the jet openings 21 is blocked by the bottom surface of the farming tank 10 and thus cannot move downward, it changes the water flow upward (hereinafter referred to as “upward water flow”) on the whole and permeates the sand layer 11 from bottom to top. As the upward water flow permeates through the sand layer 11, the sand grains forming the sand layer 11 become less packed and the leftover feed, excrement, shed shells, and other contaminants trapped in the sand layer 11 can be released into a water layer 12 above the sand layer 11.

The sand layer 11 above the water feed pipes 20 may be of any thickness selected as deemed necessary according to the type, etc., of the farmed aquatic organisms living in sandy soil; when farming prawns, however, a range of 10 to 40 cm is preferred. If the sand layer 11 above the water feed pipes is thinner than 10 cm, the sand floor in which prawns hide does not become thick enough when the water feed pipes 20 are laid at the bottom of the sand layer 11, and also the upward water flow and other water flows in the farming tank cause the sand to shift and thickness to vary easily. If the sand layer 11 above the water feed pipes is thicker than 40 cm, on the other hand, the sand layer 11 in which contaminants are trapped becomes thick and the effectiveness of releasing contaminants from the sand layer 11 weakens. In addition, the water-penetrating resistance of the sand layer 11 increases and a powerful pump is needed to supply water to the water feed pipes 20 at high pressure to generate upward water flow, resulting in high cost.

For the sand constituting the sand layer 11, any sand may be selected according to the type of the farmed aquatic organisms living in sandy soil. When farming prawns, for example, river sand, sea sand, etc., may be used, where preferably sand has a median grain size of 0.5 to 1.5 mm and contains sand grains of 0.2 mm or less by 20 to 50%.

The depth of the water layer 12 (water depth) may be set as deemed appropriate according to the type of the farmed aquatic organisms living in sandy soil, required water quantity, and so on.

For the farming tank 10, a water tank formed by concrete, fiber-reinforced plastic (FRP), resin sheet, etc., may be used, or a farming pond diked on a beach, etc., may be used. A concrete water tank is preferred because it is strong, resistant to water leaks, and capable of accommodating large amounts of sand and water. Preferably the farming tank 10 is shielded from the external environment so as to prevent intrusion of harmful viruses and injurious organisms from outside. The shape of the farming tank 10 may be, for example, a tetragon, hexagon, octagon, or other polygon or shape formed by rounding the corners of any such polygon, or circle, oval, and the like.

The water feed pipes 20 are equipped at the bottom of the farming tank 10 at a constant interval in such a way that they are distributed approximately evenly over the entire bottom surface of the farming tank 10. Preferably the water feed pipes 20 are made of resin to prevent corrosion. Also, while the pipes may be unbendable and rigid, or bendable and flexible, preferably they are rigid enough not to be crushed by the weight of the sand layer 11 even when water pressure is not applied inside the pipes. The water feed pipes 20 may be laid in concentric quadrilaterals or concentric circles, for example. Also, one water feed pipe 20 may be laid in a sine wave pattern, rectangular wave pattern, swirling pattern, or the like. As an example, a farming apparatus 101 comprising a circular farming tank 10 with water feed pipes 20 laid in concentric circles therein is shown in FIG. 4. In FIG. 4, members identical to those shown in FIG. 1 are denoted by the same symbols. The interval between the water feed pipes 20 laid adjacently is preferably 5 cm or more but no more than 100 cm, or more preferably 10 cm or more but no more than 50 cm. If the interval between the adjacent water feed pipes 20 is less than 5 cm, the number of water feed pipes 20 increases and the installation work becomes cumbersome, and the area in which prawns, etc., hide decreases. If the interval between the adjacent water feed pipes 20 is more than 100 cm, on the other hand, the water jetted out from the jet openings 21 does not reach the vicinity of the adjacent water feed pipes 20 easily.

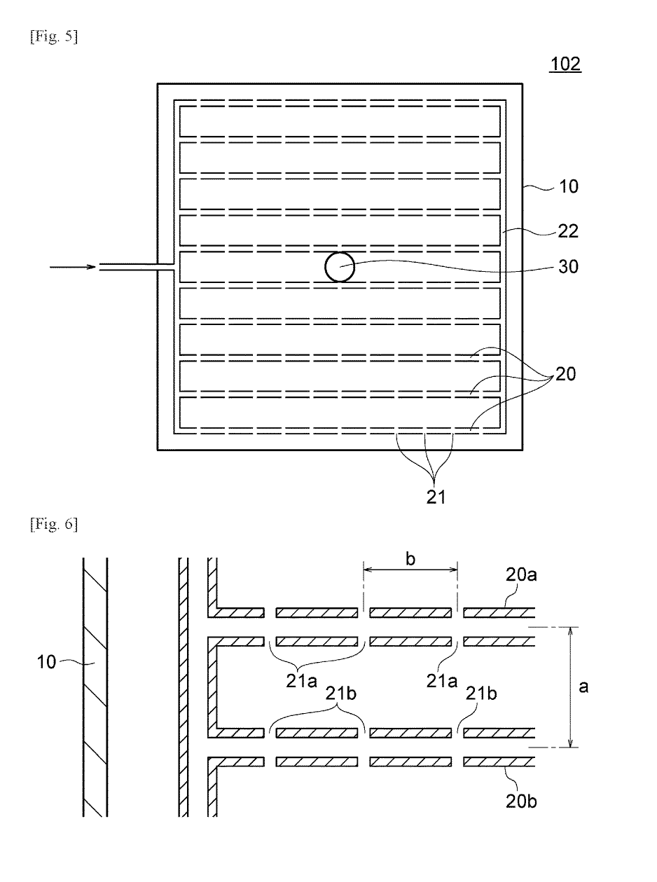

FIG. 5 shows a farming apparatus 102 having water feed pipes 20 whose ends are connected by continuous pipes 22. In FIG. 5, members identical to those shown in FIG. 1 are denoted by the same symbols. Since the water feed pipes 20 have no closed ends and are connected by the continuous pipes 22 at the ends, the pressure loss in the water feed pipes 20 becomes smaller and water can be jetted out more uniformly from each of the jet openings 21 in the water feed pipes 20.

FIG. 6 shows an enlarged view of part IV in FIG. 1.

The water feed pipes 20 have jet openings 21 arranged at a constant pitch (b) on their side faces. Preferably the pitch (b) of the jet openings 21 is smaller than an interval (a) of the water feed pipes 20. By keeping the pitch (b) of the jet openings 21 smaller than the interval (a) of the water feed pipes 20, water can be supplied uniformly to the sand layer 11 over wide areas.

Here, the water feed pipes 20 shown in FIG. 6 are such that jet openings 21a, 21b of two adjacent water feed pipes 20a, 20b are facing each other. In this case, if the momentum of water jetted out from each of the jet openings 21a, 21b is too strong, the water flows collide around the midpoint between the two water feed pipes 20a, 20b. The collision creates strong water flows upward, thus causing the upward water flows at the colliding location stronger than the upward water flows at other points, which in turn causes the sand above the colliding location to shift and the thickness of the sand layer 11 to vary, potentially reducing the area in which prawns, etc., can hide.

FIG. 7 shows an enlarged view of water feed pipes 20 where jet openings 21c, 21d of two adjacent water feed pipes 20c, 20d do not face each other. The jet opening 21c of the water feed pipe 20c does not face the jet opening 21d of the adjacent water feed pipe 20d in the sense that a distance (b′) between the normal line with respect to the wall of water feed pipe running through the center of the jet opening 21c of the water feed pipe 20c, and the normal line with respect to the wall of water feed pipe running through the center of the jet opening 21d of the adjacent water feed pipe 20d, is 0.2 times or more the pitch (b) of the jet openings 21c, 21d. The distance (b′) between the normal line with respect to the wall of water feed pipe running through the center of the jet opening 21c of the water feed pipe 20c, and the normal line with respect to the wall of water feed pipe running through the center of the jet opening 21d of the adjacent water feed pipe 20d, is preferably 0.3 times or more, or more preferably 0.4 times or more, or most preferably 0.5 times, the pitch (b) of the jet openings 21c, 21d.

When the distance (b′) between the normal line with respect to the wall of water feed pipe running through the center of the jet opening 21c of the water feed pipe 20c, and the normal line with respect to the wall of water feed pipe running through the center of the jet opening 21d of the adjacent water feed pipe 20d, is 0.5 times the pitch (b) of the jet openings 21c, 21d, jetting out water to the vicinity of the adjacent water feed pipes 20c, 20d from the respective jet openings 21c, 21d allows the upward water flows in the respective parts of the sand layer 11 to have a uniform momentum, which makes it difficult to create thickness variation across the sand layer.

The opening shape of the jet opening 21 is not limited in any way and may be circle, oval, oblong circle, quadrilateral, or the like. The maximum diameter of the jet opening 21 is preferably 0.5 mm or more but no more than 5 mm, or more preferably 1 mm or more but no more than 3 mm. If the maximum diameter of the jet opening 21 is smaller than 0.5 mm, the opening clogs easily due to foreign matter, etc. Also, the flow velocity may become too fast when the necessary quantity of water is jetting out, which may cause the sand near the jet opening 21 to shift and the thickness of the sand layer 11 to vary, thus reducing the sand floor area in which prawns, etc., can hide. Also, strong water flow inside the sand layer 11 stresses prawns, etc. If the maximum diameter of the jet opening 21 is greater than 5 mm, on the other hand, the flow of water may become weak when the necessary quantity of water is jetting out, which prevents the water from easily reaching areas away from the jet opening 21.

Water is jetted out sideways from the water feed pipes 20 through the jet openings 21 provided on the side faces of the water feed pipes 20. In the present invention, “sides” refer to directions within 30 degrees each above and below with respect to the horizontal direction, i.e., within 60 degrees in total around the horizontal direction. By jetting out water in directions within 30 degrees each above and below with respect to the horizontal direction, water can reach farther in the horizontal direction.

The water jetting out upward widens the gaps among sand grains and thus expands the sand layer 11, and spreads gradually as it moves inside the sand layer 11. On the other hand, the water jetting out downward collides with the bottom surface of the farming tank 10 and eddies to shift the sand around the collision location, and loses its flow velocity upon collision and no longer penetrates far. For these reasons, the jet direction of water is more preferably upward with respect to the horizontal direction than downward with respect to the horizontal direction. To be specific, water jets out preferably in a range of 30 degrees upward to 20 degrees downward, or more preferably in a range of 20 degrees upward to 10 degrees downward, or even more preferably in a range of 15 degrees upward to 5 degrees downward, or yet more preferably in a range of 10 degrees upward with respect to the horizontal direction, or most preferably in the horizontal direction.

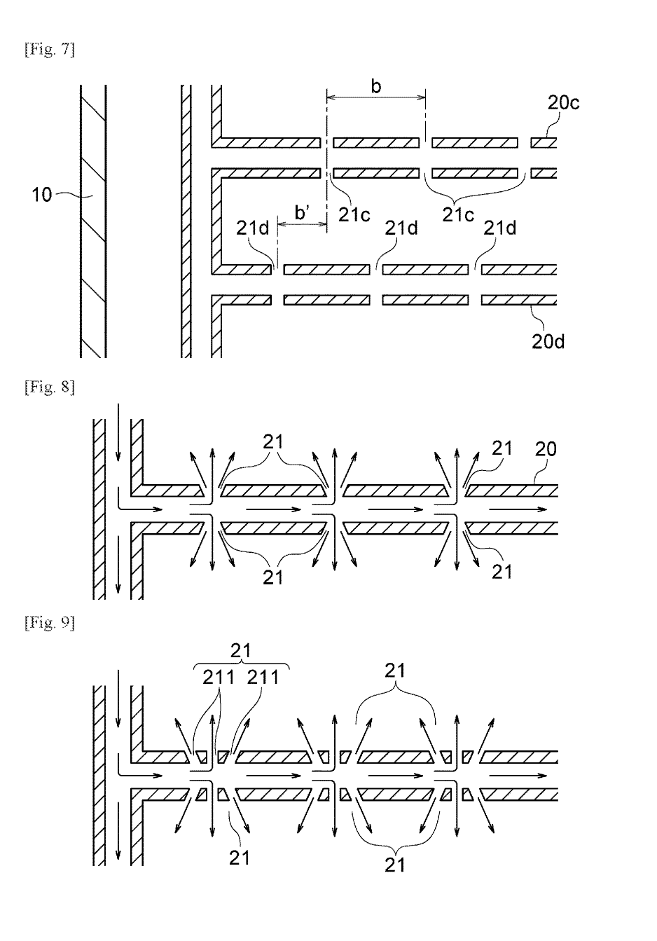

When the jet openings 21 jet out water in directions corresponding to 15 degrees or more each to the left and right with reference to the line normal to the water feed pipe 20 within the horizontal plane, i.e., within a wide angle of 30 degrees or more in total, water can be supplied to the sand layer 11 over wide areas. Methods to jet out water in directions corresponding to 15 degrees or more each to the left and right with reference to the line normal to the water feed pipe 20 within the horizontal plane, include jetting out water in a fan shape by making the jet opening 21 narrower on the inner side and wider on the outer side of the water feed pipe 20 (FIG. 8), and forming a jet opening 21 with multiple independent pores 211 and jetting out water in different directions from the respective pores 211 (FIG. 9), or the like. From the viewpoints of machinability (for making holes), strength of the water feed pipe 20, and the like, allowable jet angles are up to approx. 60 degrees each to the left and right with reference to the line normal to the water feed pipe 20. Here, the center of the jet opening 21, when the jet opening 21 is formed by multiple independent pores 211, refers to the center of the positions of the multiple pores 211.

The flow velocity of water as it is jetted out from the jet opening 21 is preferably 2.5 cm/sec or more but no more than 100 cm/sec, or more preferably 5 cm/sec or more but no more than 70 cm/sec, or even more preferably 10 cm/sec or more but no more than 50 cm/sec. If the flow velocity is slower than 2.5 cm/sec, the water jetted out from the jet opening 21 does not travel far. If the flow velocity is faster than 100 cm/sec, on the other hand, the sand around the jet opening 21 shifts and the sand layer 11 may be reduced to a thickness less than what is needed for prawns, etc., to hide. In addition, strong water flows stress prawns, etc.

The farming apparatus 100 generates upward water flows that permeate through the sand layer 11 over its entire area from bottom to top. The upward water flows make the sand grains forming the sand layer 11 less packed, and release the leftover feed, excrement, shed shells, and other contaminants trapped in the sand layer 11 into the water layer 12 above the sand layer 11. The contaminants released into the water layer 12 are discharged from the system through the drainage 30. Multiple drainage 30 may be installed. Also, a filter 31 to prevent prawns, etc., from flowing out is installed in the drainage 30. By setting up the drainage 30 at the center of the farming tank 10, the distance from each part of the farming tank 10 to the drainage can be shortened and the contaminants released into the water layer 12 from the entire area of the sand layer 11 can be discharged efficiently.

The drainage 30 may be a drain pump, or cylindrical drain outlet or drain channel designed to discharge water above a specified water level, among others. Also, water may be drained intermittently using a valve, water level sensor, etc. The farming apparatus 100 constituting the embodiment shown in FIGS. 1 and 2 has, as its drainage 30, a cylindrical drain outlet at the center of the farming tank 10. The cylindrical drain outlet comprises a pipe 32 that connects to the drain outlet and prevents sand from flowing out, as well as a cylindrical filter 31 that surrounds the pipe 32 and prevents prawns, etc., from flowing out. The cylindrical drain outlet shown in FIGS. 1 and 2 adjusts the water level based on the height of an external outlet 33, but the water level can also be adjusted by discharging water that overflows from the top open end of the pipe 32. Furthermore, the top face and upper side face of the filter 31 can be made an opening-free area and the height of the top open end of the pipe 32 can be adjusted to the height of the opening-free area of the filter 31 or higher, in order to discharge water based on the siphoning principle. Preferably the water level is adjusted based on the height of the external outlet 33 because it makes adjusting the water level easy. The cylindrical drain outlet can be installed at any location, requires no drive source, is low cost, and can adjust the water level according to the height of the external outlet 33 or pipe 32.

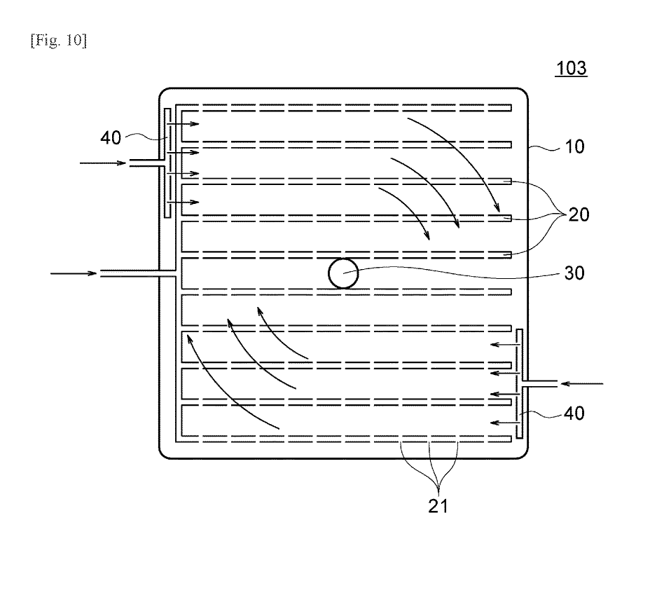

By installing a circular flow generator 40 around the interior walls of the farming tank 10, circular flows can be generated in the water layer 12. The circular flow generator 40 capable of generating circular flows in the water layer 12 may be a circulating pump or water-mill circulating apparatus, for example. Preferably a circulating pump is used for the circular flow generator 40 because it makes adjustment of circular flow velocity easy and also allows oxygen to be supplied into water. Here, preferably the farming tank 10 has no corners so that circular flows move smoothly, and preferably it has a circular shape, oval shape or shape of a polygon whose corners are rounded. Additionally, if the farming tank 10 has a shape of a polygon whose corners are rounded, circular flows can be generated efficiently by installing two or more water outlets of the circular flow generator 40 near one of the adjacent walls and by keeping the length of each water outlet to no more than one-half the length of the side. FIG. 10 shows a farming apparatus 103 having a circular flow generator 40 comprising circulating pumps whose water outlet is no longer than one-half the length of the side, installed on two opposing sides of the quadrilateral farming tank 10 whose corners are rounded by machining, near one of the adjacent walls. In FIG. 10, members identical to those shown in FIG. 1 are denoted by the same symbols.

In the depth direction, the circular flow velocity quickens in shallow areas and slows in deeper areas or areas closer to the sand layer 11. Preferably the circular flow velocity is such that the sand grains at the surface of the sand layer 11 are lightly agitated, and when farming prawns or other crustaceans, the circular flow velocity at the surface of the water layer 12 is approx. 5 to 30 cm/sec, although the specific flow velocity varies depending on the water depth.

Circular flows of appropriate velocity agitate the surface of the sand layer 11 lightly and allow for easy release, into the water layer 12, of the contaminants carried by the upward water flows to the surface of the sand layer 11 as well as the contaminants buried in the sand layer 11. Also, appropriate agitation of the surface of the sand layer 11 has the same effect as the agitation of sand by waves and tides, bringing the living environment of prawns, etc., closer to the natural environment and thereby reducing stress on prawns, etc. If the circular flow velocity is too high, on the other hand, sand grains at the surface of the sand layer 11 curls up to cause the thickness of the sand layer 11 to vary, thereby possibly reducing the area where farmed prawns, etc., can hide. Excessively high flow velocity also stresses prawns, etc.

Circular flows allow the contaminants suspended in water to be gathered at the center of the farming tank 10. The contaminants gathered at the center of the farming tank 10 can be discharged more efficiently when water is drained from the center of the farming tank 10. Here, shed shells and other large contaminants that cannot pass through the filter 31 of the drainage 30 can be scooped up with a net, etc., near the filter 31 where such contaminants gather, and disposed of. Since excessively high circular flow velocity causes the contaminants that have been released in and are suspended in the water layer 12 to spread throughout the farming tank 10 instead of gathering at the center, preferably the flow velocity is such that sand grains at the surface of the sand layer 11 are agitated lightly, as mentioned above.

The quantity of water supplied from the water feed pipes 20 is normally in a range of 0.5 to 5 m³ per 1 m² of sand layer per day (0.5 m³/m² per day or more but no more than 5 m³/m² per day). Since the capacity to release the contaminants in the sand layer 11 into the water layer 12 is determined by the velocity and spreading of upward water flows, a water supply quantity less than 0.5 m³/m² per day weakens the sand layer 11 cleaning effect. If the water supply quantity is greater than 5 m³/m² per day, on the other hand, the sand layer 11 shifts and becomes unstable, thereby stressing the farmed aquatic organisms living in sandy soil.

The total quantity of fresh water that needs to be fed for farming is determined by the quantity and rate of change of water stored in the farming tank 10. If the total quantity of fresh water required to be fed is greater than the quantity of water supplied from the water feed pipes 20, fresh water is fed from the water feed pipes 20 and a shortage of fresh water is directly (not through the water feed pipes 20) supplied to the farming tank 10 or circular flow generator 40. If the total quantity of fresh water required to be fed is smaller than the quantity of water supplied from the water feed pipes 20, on the other hand, water contained in the farming tank 10 is added to fresh water which is then fed from the water feed pipes 20.

### EXAMPLES

The present invention is explained below based on examples, but it should be noted that the present invention is not limited to these examples.

(Farming Apparatus)

A quadrilateral concrete water tank of 8 m in length, 8 m in width and 1.2 m in height was used as a farming tank. The farming tank had a drain outlet of 100 mm in bore size at the center, as well as pipe installation grooves of 200 mm in bore size that surrounded this drain outlet in concentric circles. Resin pipes of 200 mm in bore size were fitted in the pipe installation grooves so that the top faces of the resin pipes would be positioned 20 cm high from the bottom face of the farming tank. As a filter to prevent prawns from flowing out, a cylindrical resin net with a mesh size of 3 mm in length and 3 mm in width was installed on the outer periphery of the resin pipes. The height of cylindrical resin net was 120 cm. At the external outlet of the drain outlet, a resin pipe of 100 mm in bore size was installed so that it would rise to 1 m high from the bottom face of the farming tank, to allow water in the farming tank to be automatically drained to outside of the farming tank upon reaching a specified depth (1 m).

As a main water feed pipe, a resin pipe of 50 mm in diameter was installed from top to bottom at the center of one wall of the farming tank, and branched at the bottom face of the farming tank to the left and right by 4 m each along by the wall of the farming tank. The main water feed pipe branched at the bottom face of the farming tank had 40 connection holes for connecting water feed pipes, formed at intervals of 20 cm. To these connection holes, 8-m-long water feed pipes made of resin hoses and having jet openings of 1.0 mm in diameter formed at a 20 cm pitch on both side faces were connected, and the water feed pipes were installed at intervals of 20 cm over the entire area of the bottom face of the farming tank. The jet openings of the water feed pipes were positioned within a range of 10 degrees upward with respect to the horizontal direction, and the jet openings of two adjacent water feed pipes are facing each other.

River sand was laid to a height of 15 cm to form a sand layer. The resin pipe fitted into the drain outlet projected by only 5 cm from the surface of the sand layer so that sand did not flow out through the drain outlet. As mentioned above, water is collected to 1 m from the bottom face of the farming tank, which makes the water depth 85 cm (=100 cm−15 cm). It was confirmed that, when filtered seawater was fed through this main water feed pipe, water sprung up from the entire area of the sand layer and the water jetting out from the jet openings provided in each water feed pipe formed upward water flows over the entire area of the sand layer.

As a circulating pump, one 0.25-kw submersible pump was installed by suspending it from the wall of the farming tank at a height of 30 cm from the sand layer. The direction of pump outlet was adjusted to be parallel with the water surface. Also, a resin net to prevent suctioning of prawns, and an oxygen supply tube were installed at the water suction port of the circulating pump. When the circulating pump was operated, water in the farming tank circulated at a flow velocity of 20 cm/sec at the surface of the water layer.

### Example 1

The rate of changing the total water quantity fed to the farming tank was set to two rotations a day, and the entire total water fed quantity was supplied continuously from the water feed pipes. The water quantity supplied from the water feed pipes can be calculated as 1.7 m³/m² per day and the jet speed of water from the jet opening, as 50 cm/sec.

By maintaining the dissolved oxygen quantity in water at 7±1 mg/L, 3,200 prawns weighing around 5.6 g each were received and their rearing began.

For the feed, blended prawn feed manufactured by Higashimaru was supplied in once a day after sunset. For the daily feeding quantity, an appropriate amount was calculated from the number of prawns received and their weights, based on the feeding ratio recommended by the feed manufacturer. Also, shed shells and other large contaminants that could not pass through the mesh of the resin net were removed as deemed appropriate.

During the rearing period, deaths, shell shedding condition, leftover feed, etc., were observed daily by a worker diving into the tank. Also, water temperature, dissolved oxygen quantity, and pH were measured with a portable dissolved oxygen/pH meter (DM-32P manufactured by Toa DKK) twice daily in the morning and evening.

Then, 14 weeks after the start of rearing, all prawns were removed to end the rearing.

### Comparative Example 1

Prawns were reared under the same conditions as in Example 1 above, except that the conventional flow-over farming method was used (water was changed at a rate of 0.5 times per day).

Example 1 representing rearing in the farming apparatus proposed by the present invention is hereinafter referred to as the “test plot,” while Comparative Example 1 representing rearing by the conventional flow-over method is referred to as the “control plot.”

(Measurement of Sulfide Concentration)

Once every four weeks, sulfide concentration in the sand was measured at the center of the farming tank and also in the near-wall area approx. 1 m from the exterior wall of the farming tank, using gas-concentration measuring equipment (Hedrotek-S Detection Tube, Gas Sampling Pump Model 801 manufactured by Gastec).

(Weighing of Prawns)

Once every two weeks, 100 prawns were taken randomly from among the prawns being reared and weighed, after which the weight was divided by the number of prawns to calculate the average weight.

(Measured Result of Sulfide Concentration)

Table 1 shows the sulfide concentrations during the test period.

TABLE 1

| | | Sulfide concentration [mg/g] | | | |
|---|---|---|---|---|---|
| | | | | 8 weeks | 12 weeks |
| | | At start | 4 weeks later | later | later |
| Test plot | Center | 0.0 | 0.0 | 15.3 | 21.2 |
| | Near-wall area | 0.0 | 0.0 | 0.0 | 0.2 |
| Control | Center | 0.0 | 22.2 | 44.4 | 50.8 |
| plot | Near-wall area | 0.0 | 1.4 | 8.3 | 10.0 |

From the results shown in Table 1, it is inferred that in the test plot, no sulfide was detected in the sand at the center of the farming tank up to 4 weeks later, and the highest concentration of 21.2 mg/g was detected 12 weeks later. On the other hand, it is inferred that no sulfide was detected in the near-wall area of the farming tank up to 8 weeks later, and the concentration was very low at 0.2 mg/g even 12 weeks later.

By contrast, in the control plot, 22.2 mg/g of sulfide was detected in the sand at the center of the farming tank only 4 weeks later, nearly equivalent to the corresponding concentration in the test plot 12 weeks later, and the sulfide concentration in the control plot continued to rise and reached 50.8 mg/g 12 weeks later. In the near-wall area of the farming tank, 1.4 mg/g of sulfide was detected 4 weeks later, and thereafter the sulfide concentration in the sand increased with the progress of rearing and reached 10.0 mg/g 12 weeks later.

In both the test plot and control plot, higher concentrations of sulfide were detected at the center than in the near-wall areas of the farming tanks. This is because the circular flows generated by the circulating pump caused the contaminants to gather around the center of the farming tank.

In the test plot, barely any sulfide had accumulated after 12 weeks of farming, except around the drain outlet. Since less sulfide means less other contaminants, it is indicated that the contaminants to be removed in the cleaning at the end of farming are gathered around the drain outlet. Accordingly, the farming apparatus proposed by the present invention requires cleaning of the sand layer, etc., only around the drain outlet at the end of farming, allowing the cleaning to be simplified significantly or even eliminated.

(Growing Condition of Prawns)

Table 2 shows changes in average weights, while Table 3 shows changes in meat growth. Meat growth indicates the difference in average weight after two weeks, or in other words, weight increase over a two-week period.

TABLE 2

| | Average weight [g] | | | | | | | |
|---|---|---|---|---|---|---|---|---|
| | | 2 | 4 | 6 | 8 | 10 | 12 | 14 |
| | At | weeks | weeks | weeks | weeks | weeks | weeks | weeks |
| | start | later | later | later | later | later | later | later |
| Test plot | 5.6 | 8.8 | 13.0 | 17.2 | 20.8 | 23.6 | 25.9 | 28.0 |
| Control | 5.6 | 8.3 | 12.2 | 16.1 | 18.9 | 21.4 | 23.5 | 25.0 |
| plot | | | | | | | | |

TABLE 3

| | Meat growth [g] | | | | | | | |
|---|---|---|---|---|---|---|---|---|
| | Week | Week | Week | Week | Week | Week | Week | |
| | 0 to 2 | 2 to 4 | 4 to 6 | 6 to 8 | 8 to 10 | 10 to 12 | 12 to 14 | Total |
| Test plot | 3.2 | 4.2 | 4.2 | 3.6 | 2.8 | 2.3 | 2.1 | 22.4 |
| Control | 2.7 | 3.9 | 3.9 | 2.8 | 2.5 | 2.1 | 1.5 | 19.4 |
| plot | | | | | | | | |

From Table 2, the average weight of prawns in the test plot remained higher than the average weight of prawns in the control plot throughout the rearing period. Also, it is confirmed from Table 3 that the prawns in the test plot exhibited greater meat growth and grew faster than the prawns in the control plot in any period.

Table 4 shows a summary of rearing test results. Here, the feeding rate and the meet growth coefficient are calculated by the formulas below based on the quantity of the feed (F) given during the rearing period, the number of rearing days (D=95 days), and the numbers and the average weights of prawns at the start and the end of the test.

Feeding rate=F/[D×{(N_{f}+Nₒ)/2}×{(W_{f}+Wₒ)/2}]×100

Meet growth coefficient=F/[{(N_{f}+Nₒ)/2}×{(W_{f}−Wₒ)]

TABLE 4

| | Number of | | | Density | | Average | | | | |
|---|---|---|---|---|---|---|---|---|---|---|
| | prawns | | | of prawns | | weight | | Meat | Feeding | Meet |
| | Start | End | Yield | [g/m²] | | Start | End | growth | rate | growth |
| | N_{O} | N_{f} | [%] | Start | End | W_{O} | W_{f} | [g] | [%] | coefficient |
| Test plot | 3200 | 2951 | 92 | 280 | 1292 | 5.6 | 28.0 | 22.4 | 1.8 | 1.3 |
| Control | 3200 | 2744 | 86 | 280 | 1072 | 5.6 | 25.0 | 19.4 | 2.0 | 1.5 |
| plot | | | | | | | | | | |

The yield of the test plot was 92%, far exceeding the 86% yield of the control plot. Since the farming test was started with young prawns already grown to approx. 5.6 g, the yield of the control plot was 86% which was higher than general yields of conventional prawn farming (60 to 70%). It is presumed that using the farming apparatus proposed by the present invention under the actual farming conditions for the actual farming period will still improve the yield by 10% or more compared to the conventional method.

The feeding rate of prawns in the test plot was 1.8%, lower than the feeding rate of 2.0% in the control plot. A low feeding rate means that high meat growth was achieved with less feed. This also agrees with the higher meet growth coefficient of prawns in the test plot than that of prawns in the control plot. In short, it was confirmed that the test plot provided an environment more suitable for growth of prawns than did the control plot.

While the output of prawn farms is generally around 500 g per 1 m², in the test plot in this example the density of prawns was 1,292 g/m² at the end of rearing prawns; that is, prawns of approximately 2.6 times the output of the general prawn farming could be reared. The control plot also achieved a high density of 1,072 g/m², because farming was started with young prawns already grown to approx. 5.6 g, as mentioned above.

As described above, the test plot using the farming apparatus proposed by the present invention can considerably simplify, or even eliminate, the cleaning of the sand layer after farming is finished, because the sand layer is kept clean. If the sand layer need not be cleaned, the next young prawns can be received immediately after the preceding farming. If a farming period is six months and the next farming is started immediately after the preceding farming, prawns can be farmed twice per year. The farming apparatus proposed by the present invention can rear prawns at a density of 1,292 g/m². Therefore an output of approx. 2.6 kg/m² per year is expected, and thus productivity of the proposed apparatus is five times, or even more, of conventional farming.

(Appearance of Prawns)

Prawns farmed in the test plot and control plot were checked for whisker (second antenna) length. Prawns whose whisker was longer than their overall length accounted for around 80% in the test plot and around 40% in the control plot. In the test plot there were no prawns whose whisker was shorter than their head-chest part, but around 30% of the prawns in the control area exhibited such feature.

In general, high-density farming results in prawns with short whiskers, because prawns are stressed and attack each other as a result, if reared at high density. The whiskers of prawns of the test plot were longer than those of the control plot. The prawn-rearing density was lower than that of the control plot, although the farming tanks were identical in size. The reason for this difference in rearing density between the test plot and control plot can be deduced as follows.

In the test plot, generation of sulfide in the sand was suppressed over the entire area of the sand layer, which likely allowed prawns to scatter and live all over the sand layer, and made it possible to rear prawns at the rearing density calculated from the area of the farming tank.

In the control plot, on the other hand, there were areas of high sulfide concentrations. Sand in which sulfide had accumulated is an anaerobic environment where low oxygen concentration makes the area unfit for a living area for prawns. Since prawns seldom hide in sand areas of high sulfide concentrations, but gather in areas of low sulfide concentrations instead, the actual rearing density became higher than the rearing density calculated from the area of the farming tank.

When prawns are farmed using the farming apparatus proposed by the present invention, a high rate of growth is achieved with a lower feeding rate, to allow for production of prawns at significantly high yield and high farming density. Furthermore, the interval between the preceding farming and the next farming can be shortened, and thus the rate of operation of the farming apparatus can be increased. In addition, the farming apparatus proposed by the present invention allows for production of long-whiskered prawns that command high prices, since the prawns are also evaluated by appearance.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2015-215722, filed Nov. 2, 2015, the disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A farming apparatus for aquatic organisms living in sandy soil, comprising:
a farming tank; and
water feed pipes provided at a constant interval substantially all over a bottom surface of the farming tank wherein bottom parts of the water feed pipes are directly or indirectly in contact with the bottom surface;
wherein the water feed pipes each have jet openings arranged at a constant pitch on side faces.

2. A farming apparatus according to claim 1, wherein the jet openings are formed to jet out water in directions within 30 degrees each above and below with respect to a horizontal direction.

3. A farming apparatus according to claim 1, wherein a pitch of the jet openings is smaller than the interval of the water feed pipes.

4. A farming apparatus according to claim 2, wherein a pitch of the jet openings is smaller than the interval of the water feed pipes.

5. A farming apparatus according to claim 1, wherein the water feed pipes have no closed ends.

6. A farming apparatus according to claim 2, wherein the water feed pipes have no closed ends.

7. A farming apparatus according to claim 3, wherein the water feed pipes have no closed ends.

8. A farming apparatus according to claim 1, wherein the jet openings in the water feed pipes do not face the jet openings in adjacent water feed pipes.

9. A farming apparatus according to claim 2, wherein the jet openings in the water feed pipes do not face directly the adjacent jet openings in adjacent water feed pipes.

10. A farming apparatus according to claim 3, wherein the jet openings in the water feed pipes do not face directly the adjacent jet openings in adjacent water feed pipes.

11. A farming apparatus according to claim 4, wherein the jet openings in the water feed pipes do not face directly the adjacent jet openings in adjacent water feed pipes.

12. A farming apparatus according to claim 1, wherein the jet openings jet out water in directions of 15 degrees or more each to left and right with reference to a normal line running through a center of the jet opening.

13. A farming apparatus according to claim 2, wherein the jet openings jet out water in directions of 15 degrees or more each to left and right with reference to a normal line running through a center of the jet opening.

14. A farming apparatus according to claim 3, wherein the jet openings jet out water in directions of 15 degrees or more each to left and right with reference to a normal line running through a center of the jet opening.

15. A farming apparatus according to claim 4, wherein the jet openings jet out water in directions of 15 degrees or more each to left and right with reference to a normal line running through a center of the jet opening.

16. A farming apparatus according to claim 1, wherein water is drained from a center of the farming tank.

17. A farming apparatus according to claim 2, wherein water is drained from a center of the farming tank.

18. A farming apparatus according to claim 1, which has a circular flow generator installed around interior walls of the farming tank.

19. A farming apparatus according to claim 2, which has a circular flow generator installed around interior walls of the farming tank.
